(19) United States
(12) Patent Application Publication
(10) Pub. No.: US 2026/0084801 A1
(43) Pub. Date: Mar. 26, 2026

(54) Replacement Stringers

(71) Applicant: The Boeing Company, Arlington, VA (US)

(72) Inventors: Remmelt Andrew Staal, Irvine, CA (US); Ashley Revis, Charleston, SC (US); John Steven Kurtz, Mount Pleasant, SC (US); Giovanni Spampinato, Newtown, PA (US); Rebecca Baker, Huntington Beach, CA (US)

(21) Appl. No.: 18/891,128

(22) Filed: Sep. 20, 2024

(51) Int. Cl. B64C 3/18; B64F 5/40

(52) U.S. Cl. CPC B64C 3/182; B64F 5/40

(57) ABSTRACT

A replacement stringer with angle members each having a flange and a web connected together along an elbow. The flange and web are positioned at an angle relative to each other. Slots extend inward from a lateral side of the web towards the elbow. The angle members are in an overlapping configuration along a length and a width of the replacement stringer with at least the webs of two or more of the angle members overlapping.

### TECHNOLOGICAL FIELD

The present disclosure relates generally to the field of stringers and, more specifically, to stringers constructed from multiple different sections and configured to be made into complex shapes.

### BACKGROUND

In aircraft construction, a stringer is an elongated member that is fastened to and supports the skin of the aircraft. The stringers are structural members that transfer loads and stresses from the skin of the aircraft to the attached formers. Stringers can be located in various locations of the aircraft construction, including but not limited to the wings and fuselage. The stringers can include various geometries and sizes. Stringers can be constructed from a variety of materials, including but not limited to aluminum, various metals, and composite structures made up of carbon fibers and a polymer resin.

There are certain occurrences in which a stringer is removed and replaced. Replacement of a stringer can include replacing the entire stringer or replacing just the limited section of the stringer that is out of tolerance.

Existing processes for replacing a stringer include removing the stringer and replacing it with a replacement stringer. The replacement stringer matches the geometric shape and stiffness of the original stringer. A drawback to the replacement process is the replacement stringers are required to be built on a case-by-case basis. This ensures that the geometry and stiffness of the replacement stringer matches that of the original stringer. Obtaining the replacement stringer can be a lengthy process as the replacement stringer must be specifically made to meet the shape and stiffness requirements which can take an extended period of time. The replacement stringer can require custom tooling to be made to the required specifications. Further, when the stringer is used in a vehicle or other equipment, the vehicle or equipment is not operational during the extended replacement process.

### SUMMARY

One aspect is directed to a replacement stringer comprising a plurality of angle members with each of the angle members comprising: a flange and a web connected together along an elbow and positioned at an angle. Slots extend inward from a lateral side of the web towards the elbow. The angle members are in an overlapping configuration along a length and a width of the replacement stringer with the webs of two or more of the angle members overlapping.

In another aspect, the replacement stringer comprises a hat shape comprising a central flange, a pair of webs on opposing sides of the central flange, and a pair of feet on opposing sides of the pair of webs.

In another aspect, the central flange and the pair of webs are constructed from multiple ones of the angle members in the overlapping configuration and each of the feet are constructed from one of the angle members.

In another aspect, the pair of feet comprise the flange of two of the angle members.

In another aspect, the slots are evenly spaced apart along a length of the webs of the angle members.

In another aspect, the upper surface and the lower surface of the angle members are aligned parallel to one another.

In another aspect, the upper surface of a web of a first one of the angle members contacts against a lower surface of a second one of the webs of a second one of the angle members.

In another aspect, at least two of the angle members include the angle between the flange and the web being an obtuse angle.

In another aspect, the angle members are positioned along a length of the replacement stringer with the slots of the angle members misaligned.

In another aspect, the replacement stringer is connected to an interior side of a skin of an aircraft.

One aspect is directed to a replacement stringer comprising a body comprising a length that extends between a first end and a second end, and a width that extends between a first lateral side and a second lateral side. The body comprises a plurality of angle members arranged in an overlapping configuration along the length and the width with the angle members comprising flanges and webs that are positioned at predetermined angles. The webs comprise slots that are spaced apart along the length.

In another aspect, the body comprises a central flange, a first web positioned on a first lateral side of the central flange, a second web positioned on a second lateral side of the central flange, a first foot positioned on the first lateral side of the first web, and a second foot positioned on the second lateral side of the first web.

In another aspect, the angle members overlap along just the central flange, the first web, and the second web.

In another aspect, each of the angle members comprises an upper surface and a lower surface that are parallel.

In another aspect, each of the angle members comprises the slots within just the webs.

In another aspect, the slots extend completely across the webs.

In another aspect, the slots are evenly spaced apart along a length of the angle members.

In another aspect, the slots of angle members are misaligned along the length with the slots being in a non-overlapping configuration.

One aspect is directed to a method of repairing a stringer. The method comprises: positioning a first angle member and a second angle member along a section of the stringer that is out of tolerance with each of the angle members comprising a flange that is solid and a web with slots spaced apart along a length; overlapping the web of the second angle member with the web of the first angle member; mis-aligning the slots of the second angle member with the slots of the first angle member; positioning the flange of the first angle member away from the second angle member; positioning the flange of the second angle member away from the first angle member;

and connecting together the first angle member and the second angle member in an overlapping configuration.

In another aspect, the method further comprises: overlapping a flange of a third angle member with the flange of the second angle member; and connecting together the third angle member and the second angle member in an overlapping configuration.

In another aspect, the method further comprises overlapping a web of the third angle member with a web of a fourth angle member; and connecting together the third angle member and the fourth angle member in an overlapping configuration.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is an isometric view of an aircraft.

FIG. 2 is an isometric view of a support structure for a skin of an aircraft with the support structure including a repair section.

FIG. 3 is an end view of a replacement stringer that includes multiple angle members in an overlapping configuration.

FIG. 4 is an isometric view of the replacement stringer of FIG. 3.

FIG. 5 is a front view of an angle member with no exterior force being applied.

FIG. 5A is an end view of the angle member of FIG. 5.

FIG. 6 is a front view of the angle member of FIG. 5 in a bent configuration due to application of an exterior force.

FIG. 7 is an isometric view of a replacement stringer that includes multiple angle members.

FIG. 8 is a flowchart diagram of a method of repairing a stringer.

### DETAILED DESCRIPTION

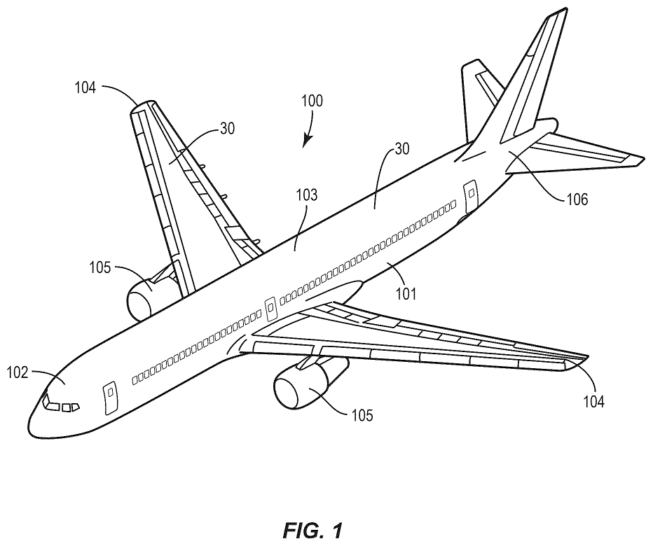

FIG. 1 illustrates an aircraft 100 configured to transport persons and/or cargo. The aircraft 100 generally includes a fuselage 101 with a flight deck 102 at a forward end, a tail section 106 at a trailing end, and an intermediate cabin area 103 configured to accommodate the passengers and/or cargo. Wings 104 extend outward from opposing sides of the fuselage 101. Engines 105 are mounted to the wings 104 and configured to propel the aircraft 100 during flight.

The aircraft 100 includes an exterior skin 30. The skin 30 can be constructed from various materials, including but not limited to aluminum and composite structures made up of carbon fibers and a polymer resin. Support structures in the interior of the aircraft 100 are connected to and support the skin 30.

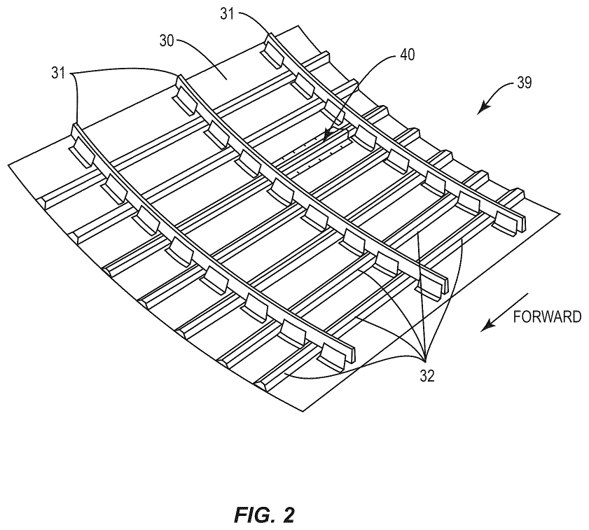

FIG. 2 illustrates a support structure 39 connected to and supporting the skin 30. The support structure 39 is connected to and extends along the interior of the skin 30. The support structure 39 includes frame members 31 that are oriented in a first direction. Stringers 40 are oriented in a second direction and extend between the frame members 31. FIG. 2 illustrates a section of the fuselage 101, although stringers 40 that support the skin 30 can be found at other sections of the aircraft 100 including but not limited to the wings 104 and tail section 106.

The replacement stringer 40 can include various sizes. In some examples, the replacement stringer 40 completely replaces the original stringer 40. In other examples as illustrated in FIG. 2, the replacement stringer 40 is just a limited section of the overall stringer 32. For example, the replacement stringer 40 replaces just a small section of a larger overall original stringer 32.

In the various examples, the original stringer 32 can be handled in different manners. In some examples, the original stringer 32 is removed and replaced with the replacement stringer 40. In other examples, the original stringer 32 remains and the replacement stringer 40 is attached over the section that is out of tolerance. In other examples, the portion of the original stringer 32 is removed and replaced with the replacement stringer 40 and connected back to the remaining original stringer 32 with two replacement stringer 40 splices.

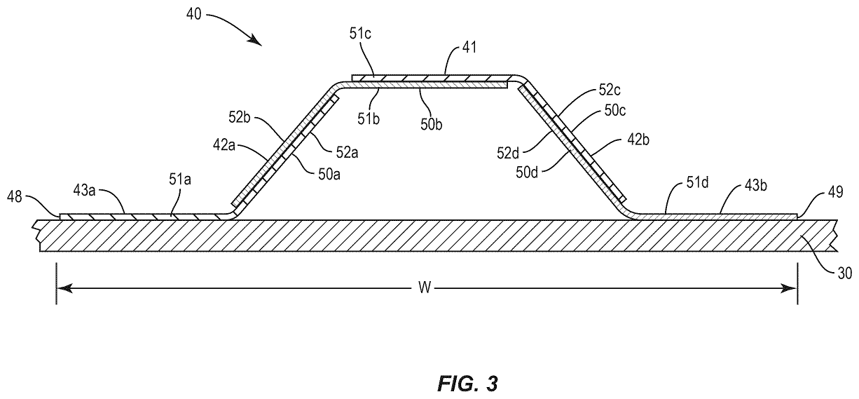

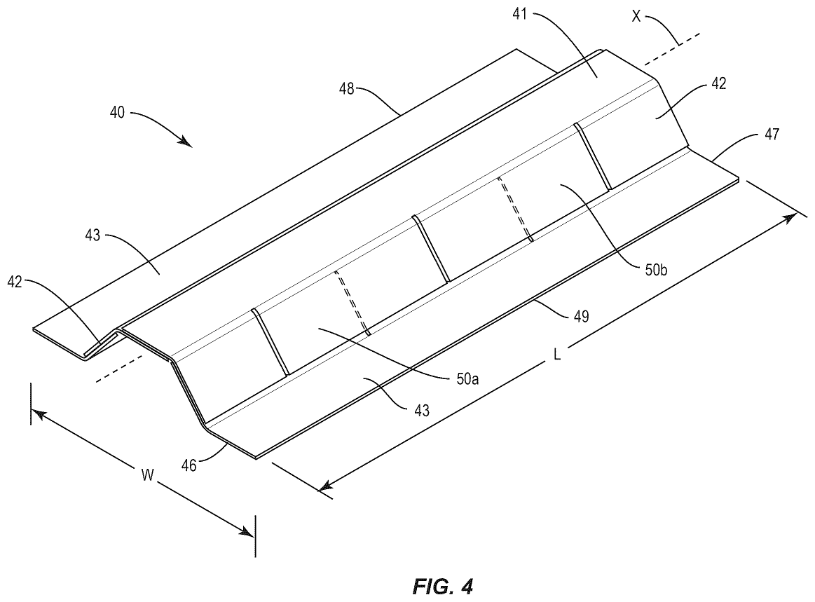

The replacement stringer 40 can include a variety of different shapes and sizes. FIGS. 3 and 4 illustrate examples of replacement stringers 40. In these examples, the replacement stringers 40 have a hat shape (i.e., a hat stringer) with a central flange 41, webs 42 and feet 43. The replacement stringer 40 includes a length L measured between a first end 46 and a second end 47, and a width W measured between a first lateral side 48 and a second lateral side 49. A longitudinal centerline X extends along the length L. Fasteners (not illustrated) extend through the feet 43 to connect the stringer 32 to the skin 30.

The replacement stringer 40 includes multiple angle members 50 that are connected together in an overlapping configuration. The angle members 50 overlap one another along the length L and across the width W. The number of overlapping angle members 50 can vary, with some examples as illustrated in FIG. 3 having two overlapping angle members 50 and other examples having three or more overlapping angle members 50. The amount of overlap can vary along the length L and width W. As illustrated in FIGS. 3 and 4, the flange 41 is formed by two angle members 50b and 50c, web 42a is formed by angle members 50a and 50b, web 42b is formed by angle members 50c and 50d, foot 43a is formed by angle member 50a, and foot 43b is formed by angle member 50d. The angle members 50 combine together and form the overall shape of the replacement stringer 40. The angle members 50 are connected together in various manners including but not limited to fasteners and adhesives.

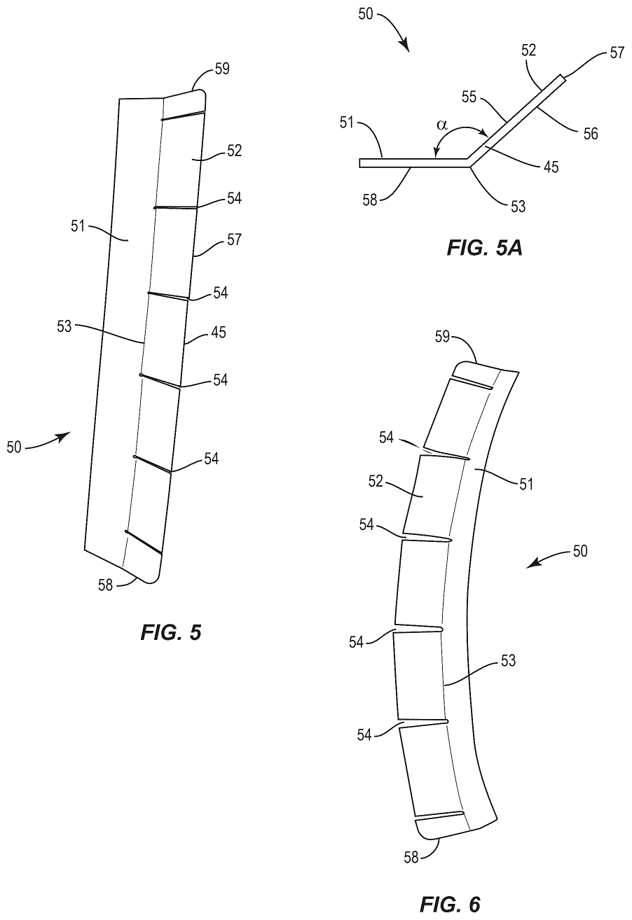

FIGS. 5 and 5A illustrate an example of an angle member 50. The angle member 50 has a unitary, one-piece body 45 that includes a flange 51 and a web 52. The flanges 51 and webs 52 are aligned at various angles relative to one another. In this example, the angle member 50 includes a flange 51, a web 52, and an intermediate elbow 53. The elbow 53 positions the flange 51 and web 52 at an angle a. The angle a can vary depending upon the shape of the replacement stringer 40, with exemplary angles ranging from 90° to 150°.

The angle member 50 includes an upper surface 55 and a lower surface 56. In some examples, the surfaces 55, 56 are substantially flat, with other examples including various undulations. In some examples, the angle member 50 includes a substantially equal thickness with the upper surface 55 parallel with the lower surface 56. In some examples, the angle member 50 is relatively thin (measured between the surfaces 55, 56) relative to the length L and width W. This small thickness enables the angle member 50 to be bent and otherwise deformed to conform to the shape of the skin 30. The angle members 50 can be constructed from a variety of different materials, including but not limited to aluminum, metal, composites of resin and carbon fibers.

The angle member 50 includes slots 54 that are spaced apart along the length. In some examples, the slots 54 are evenly spaced apart along the length, with other examples including an uneven distribution. In some examples as illustrated in FIG. 5, the slots 54 extend across the entire width of the web 52 from a lateral side to the elbow 53. Other examples include the slots 54 extending a lesser distance into the web 52 from the lateral side. In some examples, the flange 51 is solid (i.e., without slots) as the slots 54 terminate in the web 52 and/or elbow 53. In the example of FIG. 5, the flange 51 is solid and the web 52 includes slots 54.

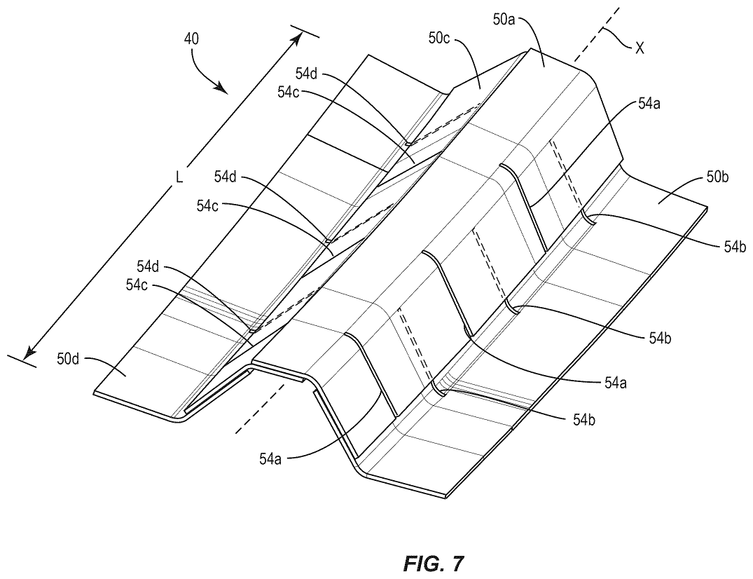

The angle member 50 is flexible to conform to the shape of the skin 30. FIG. 6 illustrates the angle member 50 in a bent configuration along its length due to the application of an exterior force. The slots 54 have an enlarged shape that corresponds to the bend. The slots 54 facilitate bending of the replacement stringer 40 within one or more dimensions.

The replacement stringer 40 is constructed from multiple angle members 50 that are in an overlapping configuration. The number of angle members 50 and their relative positioning can vary. In some examples as illustrated in 4, the different angle members 50 are offset along the length L such that the slots 54 of the overlapping angle members 50 are misaligned. For example, the slots 54 of the first angle member 50a are offset along the length L from the slots 54 of the second angle member 50b. This prevents alignment of the slots 54 of multiple angle members 50 which could weaken the replacement stringer 40 and prevent it from adequately supporting the skin 30.

The number and positioning of the angle members 50 can vary. In one example of FIG. 3, the replacement stringer 40 is constructed from four angle members 50a, 50b, 50c, 50d. Each angle member 50 overlaps with one or more other angle members 50. For example, angle member 50a overlaps with angle member 50b. Angle member 50b overlaps with both angle members 50a and 50c. Angle member 50c overlaps with both angle members 50b and 50d. Angle member 50d overlaps with angle member 50c.

The multiple angle members 50 in the replacement stringer 40 can include the same or different shape and/or size. In the example of FIG. 3, each of the angle members 50 is substantially the same with a flange 51 and a web 52 aligned at an obtuse angle. In other examples, the angle members 50 are different.

In some examples, the different angle members 50 are aligned relative to one another such that the webs 52 with slots 54 overlap one another and the flanges 51 that are solid overlap one another. FIG. 3 illustrates this overlapping configuration with webs 42a and 42b constructed from webs 52 of the angle members 50 that include slots 54. The central flange 41 is constructed from solid flanges 51 from angle members 50b, 50c. The overlapping webs 52 with slots 54 facilitate bending the replacement stringer 40 to conform to the skin 30. In other examples, overlapping sections include both solid and slotted configurations.

In some examples, the replacement stringer 40 includes multiple sides that each are formed by two or more overlapping angle members 50. In other examples, the replacement stringer 40 includes one or more sides that are not formed by overlapping angle members 50. One example is illustrated in FIG. 3 with each of the feet 43a, 43b formed by just a single angle member 50 (i.e., foot 43a is formed by flange 51a of angle member 50a and foot 43b is formed by flange 51d of angle member 50d).

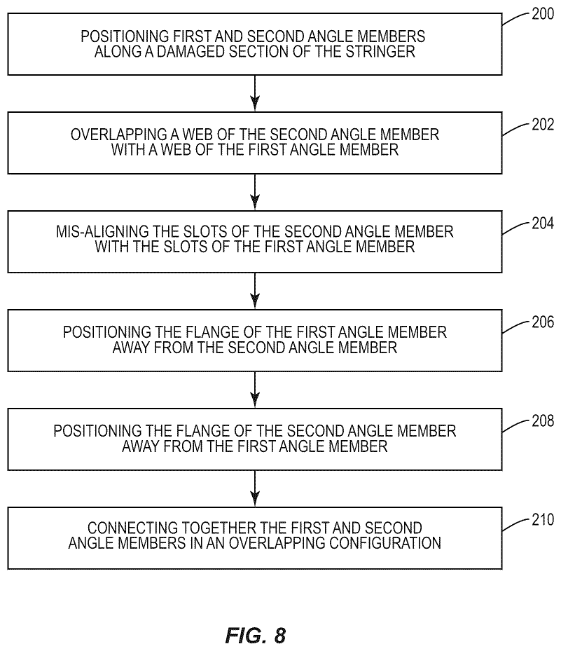

The replacement stringer 40 is constructed to have the necessary stiffness to support the skin 30. The replacement stringer 40 is also constructed to be bent and shaped to conform to the skin 30. FIG. 7 illustrates an example of a repair stringer 40 with a curved shape along the length L. This causes the longitudinal centerline X to be curved. The angle members 50a, 50b, 50c, 50d are offset relative to each other for the slots 54 of the overlapping angle members 50 to be misaligned. This is most clearly illustrated with slots 54a of angle member 50a offset from the slots 54b of the angle member 50b.

FIG. 8 illustrates a method of repairing a stringer 32. The method includes positioning a first angle member 50a and a second angle member 50b along a section of the stringer 32 that is out of tolerance (block 200). Each of the angle members 50a, 50b comprises a flange 51 that is solid and a web 52 with slots 54. The positioning includes overlapping the web 52 of the second angle member 50b with the web 52 of the first angle member 50a (block 202). The positioning further includes misaligning the slots 54 of the second angle member 50b with the slots 54 of the first angle member 50a (block 204). The method includes positioning the flange 51 of the first angle member 50a away from the second angle member 50b (block 206) and positioning the flange 51 of the second angle member 50b away from the first angle member 50a (block 208). The angle members 50a, 50b are connected together in the overlapping configuration (block 210).

In some examples, one or more additional angle members 50 are connected to the combined structure. The additional angle members 50 can be connected to the first angle member 50a or the second angle member 50b. One example is illustrated in FIG. 3 that includes additional angle members 50c, 50d connected to angle members 50a, 50b.

The stringers 40 can include a variety of sectional shapes configured to support the skin 30. One example is a hat stringer as illustrated in FIGS. 3, 4, and 7. Other examples include but are not limited to a C or L channel shape, a Z shape, a T or blade shape, an I shape, and a J shape.

The device 10 can be used on a variety of applications. One example is within vehicles 100. Vehicles 100 include but are not limited to manned aircraft, unmanned aircraft, manned spacecraft, unmanned spacecraft, manned rotorcraft, unmanned rotorcraft, satellites, rockets, missiles, manned terrestrial vehicles, unmanned terrestrial vehicles, manned surface water borne vehicles, unmanned surface water borne vehicles, manned sub-surface water borne vehicles, unmanned sub-surface water borne vehicles, and combinations thereof. Other applications include but are not limited to industrial equipment and support walls.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A replacement stringer comprising:
a plurality of angle members, each of the angle members comprising:
a flange and a web connected together along an elbow and positioned at an angle relative to one another the flange comprising a flange lateral side opposite from the elbow and the web comprising a web lateral side opposite from the elbow;
slots that extend inward from the web lateral side towards the elbow, the slots positioned along the web and away from the flange; and
wherein the flange lateral side is continuous without the slots;
wherein the angle members are in an overlapping configuration along a length and a width of the replacement stringer with the webs of two or more of the angle members overlapping.

2. The replacement stringer of claim 1, wherein the replacement stringer comprises a hat shape comprising:
a central flange;
a pair of webs on opposing sides of the central flange; and
a pair of feet on opposing sides of the pair of webs.

3. The replacement stringer of claim 2, wherein the central flange and the pair of webs are constructed from multiple ones of the angle members in the overlapping configuration and each of the feet are constructed from one of the angle members.

4. The replacement stringer of claim 3, wherein the pair of feet comprise the flange of two of the angle members.

5. The replacement stringer of claim 1, wherein the replacement stringer is connected to an interior side of a skin of an aircraft.

6. The replacement stringer of claim 1, wherein an upper surface and the lower surface of the angle members are aligned parallel to one another.

7. The replacement stringer of claim 1, wherein an upper surface of the web of a first one of the angle members contacts against a lower surface of a second one of the webs of a second one of the angle members.

8. The replacement stringer of claim 1, wherein at least two of the angle members comprise the angle between the flange and the web being an obtuse angle.

9. The replacement stringer of claim 1, wherein the angle members are positioned along a length of the replacement stringer with the slots of the angle members misaligned.

10. A replacement stringer comprising:
a body comprising:
a length that extends between a first end and a second end;
a width that extends between a first lateral side and a second lateral side;
wherein the body comprises a plurality of angle members arranged in an overlapping configuration along the length and the width, the angle members comprising flanges and webs that are positioned at predetermined angles; and
wherein the webs of the angle members comprise slots that are spaced apart along the length and with the slots positioned away from outer sides of the flanges that extend along the length such that outer sides of the flanges are uninterrupted.

11. The replacement stringer of claim 10, wherein the body comprises:
a central flange;
a first web positioned on a first lateral side of the central flange;
a second web positioned on a second lateral side of the central flange;
a first foot positioned on the first lateral side of the first web; and
a second foot positioned on the second lateral side of the first web.

12. The replacement stringer of claim 11, wherein the angle members overlap along just the central flange, the first web, and the second web.

13. The replacement stringer of claim 10, wherein each of the angle members comprises an upper surface and a lower surface that are parallel.

14. The replacement stringer of claim 10, wherein each of the angle members comprises the slots within just the webs.

15. The replacement stringer of claim 14, wherein the slots extend completely across the webs.

16. The replacement stringer of claim 14, wherein the slots are evenly spaced apart along a length of the angle members.

17. The replacement stringer of claim 10, wherein the slots of the angle members are misaligned along the length with the slots being in a non-overlapping configuration.

18. A method of repairing a stringer with the replacement stringer of claim 1, the method comprising:
positioning a first one of the angle members and a second one of the angle members along a section of the stringer that is out of tolerance;
overlapping the web of the second angle member with the web of the first angle member;
mis-aligning the slots of the second angle member with the slots of the first angle member;
positioning the flange of the first angle member away from the second angle member;
positioning the flange of the second angle member away from the first angle member;
connecting together the first angle member and the second angle member in an overlapping configuration.

19. The method of claim 18, further comprising:
overlapping the flange of a third one of the angle members with the flange of the second angle member; and
connecting together the third angle member and the second angle member in an overlapping configuration.

20. The method of claim 19, further comprising:
overlapping the web of the third angle member with the web of a fourth one of the angle members; and
connecting together the third angle member and the fourth angle member in an overlapping configuration.
